(19) United States
(12) Patent Application Publication
(10) Pub. No.: US 2022/0174917 A1
(43) Pub. Date: Jun. 9, 2022

(54) WATERCRAFT AND METHOD FOR THE PRODUCTION OF AQUATIC ORGANISMS

(71) Applicant: HOCHSCHULE FÜR TECHNIK UND WIRTSCHAFT DES SAARLANDES, Saarbrücken (DE)

(72) Inventors: Klaus KIMMERLE, Homburg (DE); Gerhard BRAUN, Püttlingen (DE); Uwe WALLER, Saarbrücken (DE); Stefan WEISSKIRCHER, Illingen (DE)

(21) Appl. No.: 17/426,379

(22) PCT Filed: Jan. 29, 2020
(86) PCT No.: PCT/DE2020/100056

§ 371 Date: Jul. 28, 2021

(30) Foreign Application Priority Data
Jan. 29, 2019 (DE) 10 2019 102 223.1

(51) Int. Cl. A01K 61/60; A01K 61/10; A01K 61/80; B01D 29/31; B01D 29/66; B01D 29/96; B01D 41/04

(52) U.S. Cl. CPC A01K 61/60; A01K 61/10; A01K 61/80; B01D 41/04; B01D 29/66; B01D 29/96; B01D 29/31

(57) ABSTRACT

A watercraft for breeding aquatic organisms, including an aquaculture facility and a device for feeding water into the aquaculture facility so that water intended to be fed into the aquaculture facility can escape from a body of water in which the watercraft is floating. A feed opening for receiving the water from the body of water is open in the longitudinal direction of the watercraft and/or is arranged below a water line of the watercraft. The feed opening is arranged on the hull of the watercraft, preferably on the bow. The watercraft includes a device for letting out water from the aquaculture facility to the body of water. An outlet opening of the outlet device is open in the longitudinal direction of the watercraft and/or is arranged below the water line of the watercraft. The outlet opening preferably being arranged on the hull of the watercraft, on the bow thereof.

The invention relates to a watercraft for production, in particular breeding and/or farming, of aquatic organisms, and to a method for production of aquatic organisms.

Watercrafts by way of which fishing is carried out are well known from use. They are used inter alia for towing nets for the purpose of catching fish and for holding and transporting the catch obtained with the nets. What is problematic is that, when fishing is carried out, a considerable portion of by-catch is obtained and overfishing occurs.

Also known from use are aquaculture systems, which are used in particular for farming and breeding of aquatic organisms, such as fish, mollusks, crustaceans, plants and algae.

The invention is based on the object of providing a watercraft by way of which fishing can be carried out in an environmentally sound manner.

According to the invention, said object is achieved in that an aquaculture system, in particular for fish production, that is to say breeding and/or farming of fish, is arranged in the watercraft, and the watercraft has a device for feeding water into the aquaculture system that is provided in such a way that the water intended to be fed into the aquaculture system can be taken from a body of water in which the watercraft is floating.

By virtue of its arrangement in the watercraft, the aquaculture system is not only mobile but also can be supplied with fresh water in a relatively simple manner. This yields various advantages.

Firstly, the aquaculture system can be supplied with water from a body of water which offers suitable conditions for breeding the respective organisms, in particular with regard to water temperature, water quality and/or other water properties. In comparison with an aquaculture system set up on land, energy and also outlay for temperature control and/or for treatment of the water, such as for introduction and/or removal of gas and/or for cleaning, in particular for removal of excreta or dead organisms, can be avoided, and costs can thus be saved to a considerable extent.

Furthermore, the possibility is created for relocating the farming away from coasts, where it is conventionally carried out, to places far from the coast. In this way, it is possible not only to avoid pollution of near-coastal bodies of water that is associated with the farming and consists in particular in the discharge of waste materials such as excreta of organisms or dead organisms. Rather, it is also possible, through travel of the watercraft, to release the discharge not merely locally at a single location, but at different locations, for example in that, when the watercraft is traveling, the waste materials are released continuously. Since the impurities caused by the organisms are normally fully degraded in a natural way in bodies of water if not present in excessively large amounts, the aquaculture system according to the invention creates only a relatively small amount of or no pollution, which can degrade naturally much more effectively and faster than that from conventional, stationary aquaculture systems. The discharge of the waste materials furthermore yields the advantage that the body of water can receive materials which can have a positive effect on the status of the body of water.

The invention can be used particularly advantageously if the watercraft is made to travel on the body of water along a route on which, preferably owing to the water temperature and other properties of the body of water, suitable conditions for keeping the aquatic organisms prevail.

In one embodiment of the invention, the watercraft has with at least one device for generating energy, wind and/or solar energy. On the watercraft, it would be possible for example for at least one wind energy system or photovoltaic system to be provided.

The invention proves to be particularly environmentally friendly if the watercraft is a sailing ship. It can then be driven by wind power, and the water can, without energy to be used additionally, be moved from the body of water into and out of the aquaculture system. It goes without saying that the invention can advantageously also be used advantageously in a watercraft which is driven, preferably in addition to drive by wind power, by a motor, possibly through use of renewable energy, such as solar energy.

If the absorbed wind energy and/or solar energy are/is greater than for driving the watercraft at a speed necessary for the operation, the absorbed wind energy and/or solar energy could be used for charging an energy store, in particular a battery, or for operating the aquaculture system or other devices of the watercraft.

In one configuration of the invention, the watercraft has at least one turbomachine, for example a turbine, in particular a kinetic fluid-flow turbine, by means of which electrical energy can be generated when the watercraft is moving in the body of water through use of a flow of the water relative to the watercraft that is formed in the process.

The use of the turbomachine proves to be advantageous if more wind energy and/or solar energy are/is absorbed than is necessary to move the watercraft at a speed which allows a supply of water to the aquaculture system owing to the movement of the watercraft.

Expediently, by way of the turbomachine, at most an amount of energy is received such that the watercraft travels at a minimum speed necessary for providing a supply to the aquaculture system.

In one configuration of the invention, the watercraft has a regulating device which is configured for regulating a travel speed of the watercraft relative to the water of the body of water, for regulating an energy absorption by means of the turbomachine and/or for regulating a throughflow rate of the water through the aquaculture system. Expediently, the watercraft has a device for measuring the travel speed, a device for measuring the energy absorption and/or a device for measuring the throughflow rate. A manipulated variable of the regulation is expediently the indicated variable of the energy absorption by means of the turbomachine.

Preferably, a regulated variable of the regulation is the travel speed and/or the throughflow rate.

In a particularly preferred embodiment of the invention, the regulating device is provided to provide a maximum travel speed and/or a maximum throughflow rate as the regulated variable, wherein preferably the energy absorption by means of the turbomachine is set in such a way that the maximum travel speed and/or a maximum throughflow rate are/is not exceeded.

Expediently, a feed opening of the feed device for receiving the water from the body of water is open in the longitudinal direction of the watercraft, preferably in the travel direction thereof, in particular toward the bow, and/or is arranged below a waterline of the watercraft. The feed opening is preferably arranged in the hull of the watercraft, particularly preferably at the bow thereof. If the watercraft is made to travel in the body of water, the relative movement of the watercraft in relation to the body of water can be used to move the water into the aquaculture system.

In one configuration of the invention, the aquaculture system has at least one tank in which organisms to be bred are to be kept. The tank is arranged in a hull of the watercraft, expediently at least sectionally below the waterline of the watercraft.

In one embodiment of the invention, the hull of the watercraft has a shape which is suitable for promoting the formation of the largest possible stagnation pressure, and/or the build-up of the largest possible stagnation wave, in the region of the feed opening when the watercraft is moving. For this purpose, the hull could have, at least in the region of the feed opening, a wall which is arranged in such a way that a normal vector to the wall is arranged at an angle of no more than 20° to the longitudinal direction of the watercraft. Additionally or alternatively, in the region of the feed opening, the hull could be shaped in such a manner that, when the watercraft is moving, the water is conducted toward the feed opening. The hull could have for example a funnel-like shape in the region for this purpose. Advantageously, such a shaping of the hull, when the watercraft is moving, results in the formation of a stagnation pressure, and/or a large stagnation wave, by way of which the water can be moved toward the aquaculture.

As an alternative to the arrangement of the feed opening directly in the hull of the watercraft, a feed line projecting from the hull and leading to the aquaculture system that has the feed opening could be provided. The feed line could, for example, project from a longitudinal side, that is to say port and/or starboard side, or from the bow, of the hull.

In one configuration of the invention, the aquaculture system has a device for discharging water from the aquaculture system into the body of water. Expediently, an outlet opening of the outlet device is open in the longitudinal direction of the watercraft and/or is arranged below the waterline of the watercraft. In one embodiment of the invention, the outlet opening is arranged in the hull of the watercraft, preferably at the stern thereof. Advantageously, when the watercraft is moving in the body of water, a wake is formed at the outlet opening, which wake draws the water out of the aquaculture system.

In one embodiment of the invention, the feed opening and the outlet opening in the aquaculture system are connected in terms of flow in such a way that, when the watercraft moves on the body of water, a flow from the feed opening toward the outlet opening is formed within the aquaculture system. The feed device and the outlet and/or drainage device are preferably formed separately from one another in such a way that the water to be fed and the water to be discharged and/or drained cannot mix with one another outside the stated tank.

Expediently, the aquaculture system comprises a device for draining the waste materials, which device is preferably separate from the outlet device.

The outlet device and/or the drainage device preferably have/has with a device for reducing the solid materials in size, in particular the stated waste materials, such as the excreta or the dead organisms, and/or with a sediment collector for collecting solid materials, in particular waste materials. The pump of the outlet device and/or the drainage device could be a comminution pump.

In one embodiment of the invention, the watercraft is configured to move the water from the body of water continuously into the aquaculture system and preferably to continuously release water from the aquaculture system into the body of water. Expediently, impurities such as waste materials or excreta, which are produced by the organisms, are released together with the water to the body of water.

In one configuration of the invention, the feed opening is provided with a material-separating device, preferably a filter and/or a rake, in order to avoid impurities passing from the body of water into the aquaculture system. Expediently, the feed device is configured to clean the material-separating device. Cleaning is preferably realized by backflushing and/or by mechanical stripping of the impurities. The backflushing could be realized by means of a pump. It would also be conceivable for the watercraft, for the purpose of backflushing, to be moved in the reverse direction and, in this way, for a flow in the reverse direction to be generated in the aquaculture system and the feed and outlet devices, in order in this way for the filter to be freed of impurities.

In one embodiment of the invention, the material-separating device is arranged at the feed opening in such a way that, in a filtering position, it can be arranged before the feed opening and, in an outlet position, it can be arranged away from the feed opening. If the feed opening is used for discharging water from the aquaculture system, the material-separating device can be moved into the the outlet position and does not hinder the discharge of, in particular small-particle, solid materials.

In a further configuration of the invention, the material-separating device comprises a filter device which is formed from multiple filter parts, which, for the cleaning thereof, can be removed from the filter device in each case individually and separately from the other filter parts. The filter device, which is preferably configured for being arranged in the pipeline, is expediently provided in such a way that it performs its filtering function even if at least one of the filter parts has been removed from the filter device for the purpose of cleaning.

In one embodiment of the invention, the filter device is provided in such a way that the filter parts, in particular by rotation, can be arranged in a filtering position in which they can filter the water passing through, and can preferably be brought from the filtering position into a removal position in which, for the purpose of cleaning, they can be removed from the filter device.

In particular for the variant in which the filter device is provided for being arranged in the pipeline, the filter device has a cylindrical, in particular circular-cylindrical, shape, in particular such that it can be arranged in a fitting manner in the pipeline.

Expediently, a filter portion of the filter device, which filter portion is formed for example by a grid, a mesh or a perforated sheet, forms a hollow cylinder, so that material to be separated by the filter device is arranged on the inner and/or outer side of the filter region on the lateral surface and water can flow in or out through the hollow space of the hollow cylinder. The hollow cylinder is preferably a, preferably right, hollow circular cylinder. The stated filter parts preferably form in each case one part of the filter portion, so that the filter portion can be assembled from the filter parts. The filter portions of the filter parts preferably individually have in each case a surface of such a size that they completely cover an outflow or inflow region through which the water passes through the pipeline. The outflow or inflow region may be formed for example by an opening in the lateral surface of the pipeline. It goes without saying that the number of filter parts to be provided that together form the filter device depend on the size of the outflow or inflow region. It has proven to be particularly expedient to form the filter device from three or four filter parts, which are preferably equal in size. Then, in the case of a filter device in the form of a hollow circular cylinder, the filter parts each constitute a circular segment of a cylinder of 120° or 90°.

For the removal and the insertion of the filter parts, it has proven to be particularly advantageous to provide the filter parts in such a way that the straight longitudinal sides thereof are formed parallel to the cylinder axis. The filter parts may each be provided with a holding device, for example a connecting bar or the like, by way of which, for forming the filter device, said filter parts can abut against one another. The holding device may also form a counter-holder for the removal or the insertion of the filter parts respectively from or into the filter device.

An apparatus for rotating the filter device and the pipeline and/or for, possibly automatically, removing and inserting the filter parts may be provided for the filter device.

During operation, the filter parts are inserted into the pipeline in such a way that the filter portion of a single filter part which is arranged in the filtering position completely covers the outflow or inflow region. As soon as said filter part is to be cleaned, the filter device is arranged in the pipeline, preferably by rotation of the filter device, in such a way that the filter part is moved away from the outflow or inflow region and is moved into the removal position and another filter part is brought into the filtering position such that it completely covers the outflow or inflow region. While the former filter part can then be removed, the latter filter part performs the filter function. Advantageously, the filter device remains functional even if one of its filter parts has been removed.

Additionally, there may be provided an apparatus for cleaning the filter device by means of which material which has been arranged on the filter device can be removed from the filter device. The cleaning device could comprise for example a rake, which is matched in terms of its shape, or a flushing lance.

The material-separating device, in particular the filter device, described may also be used for purposes other than the watercraft described here. For example, the material-separating device could be provided for filtering liquids in hydraulic systems, such as hydraulic pumps or hydraulic presses.

What proves to be particularly advantageous for this purpose is a further configuration of the invention, according to which the watercraft has such a form that it can be moved in both directions while water is fed from the body of water into the aquaculture system along the longitudinal axis of the watercraft. For this purpose, it may be provided that the watercraft has an identical or at least similar shaping at its bow and stern.

In particular in the case in which the feed opening and the outlet opening are arranged on the longitudinal side of the watercraft, that is to say on the port and/or starboard side, the feed device and the outlet device could be provided in such a way that the orientations of the feed opening and of the outlet opening can be changed, preferably can be arranged in the in each case opposite direction. Advantageously, it is then possible, by changing of the orientation of the feed and/or outlet opening, to reverse the flow direction within the aquaculture system when the watercraft is traveling.

In a particularly preferred configuration of the invention, the watercraft has at least one pipeline which connects the feed opening and the outlet opening directly to one another and is preferably led through the hull in the longitudinal direction of the hull. Preferably, the pipeline has, both at the feed opening and at the outlet opening, a device for closing off the respective opening, for example a flap or a valve. Expediently, at least two of the pipelines are provided, and the pipelines are connected in terms of flow to the tanks. A flow within the tanks can be achieved in that the feed opening of one of the pipelines is opened and the outlet opening thereof is closed and at another pipeline, conversely, the feed opening is closed and the outlet opening is opened. When the watercraft is traveling through the body of water, the water, with the formation of a stagnation pressure, is pushed through the feed opening into one pipeline and into the tank. The water flows to the outlet opening, and back into the body of water, through the other pipeline. Advantageously, this provides a particularly simple arrangement for allowing the water to flow through the tank of the aquaculture system. Furthermore, it is possible to reverse the flow direction in the pipelines and the tank in that, at the pipeline whose feed opening was open and outlet opening was closed, the feed opening is closed and the outlet opening is opened, and conversely at the other pipeline, at which the feed opening was closed and the outlet opening was open, the feed opening is opened and the outlet opening is closed.

Expediently, the stated turbomachine is arranged in the pipeline. Advantageously, firstly it is possible for the flow speed in the aquaculture system to be influenced by means of the turbomachine. Secondly, the turbomachine can be used like a pump for moving water through the aquaculture system, for example if the watercraft does not move or does not move sufficiently fast.

It would be conceivable to provide in the pipeline sectionally, for example as bypass, with at least two parallel pipe portions which can be closed off, and opened, separately from one another. If the turbomachine is arranged in one of the pipe portions, it is possible, according to requirement, for the water to be conducted through the pipe portion with the turbomachine for the purpose of energy absorption and possibly for the other pipe portion to be closed, or, if no energy is to be absorbed by way of the turbomachine, for pipe portions with the turbomachine to be closed and for the water to be conducted through the other pipe portion.

Alternatively or additionally, the turbomachine could be arranged on the hull of the ship in such a way that it can be folded in and folded out.

According to one embodiment of the invention, a line of the aquaculture system is formed by an open watercourse, in particular a channel. Such an open watercourse is suitable particularly as a line departing from the feed opening and leading to the aquaculture system and is expediently formed at least sectionally below the waterline in the hull of the watercraft.

Expediently, the tank of the aquaculture system is formed at least partially below the watercourse, so that the water can flow from the watercourse toward the tank. It would also be conceivable for the hull to have two or more float bodies which are separated from one another by one or more, and for the open watercourse to be formed between the float bodies.

In order for a supply of water from the body of water to the aquaculture system to be made possible if the watercraft is not being made to travel on the body of water, in one embodiment of the invention, the aquaculture system is provided with a pump device by means of which the water can be pumped from the body of water into the aquaculture system. Alternatively or additionally, a pump by means of which water can be pumped out of the aquaculture system via the outlet device may be provided. It would furthermore be conceivable for the pump of the feed device and/or that of the outlet device to be used for driving the watercraft.

In one configuration of the invention, the feed device, in particular the feed opening, and/or the outlet device, in particular the outlet opening, can be closed off with respect to the body of water. Advantageously, the aquaculture system can be separated from the body of water if passage of water from the body of water into the aquaculture system is to be avoided, for example because of impurities in the body of water.

In a preferred configuration of the invention, the aquaculture system is provided with a device for treating the water situated in the aquaculture system. The treatment system is preferably configured for cleaning of solid materials, preferably by filtration, flotation and/or sedimentation, for introducing gas, for example oxygen or ozone, and/or removing gas, for example carbon dioxide and/or nitrogen, for nitrification and/or for denitrification. Additionally or alternatively, the treatment device may be provided for increasing the oxygen content in the water, for example by increasing the oxygen content of the gas for introduction, and/or for reducing the nitrogen content in the water, preferably by means of pressure swing adsorption. Advantageously, the aquaculture system can then be operated in the state closed with respect to the body of water.

Furthermore, the treatment device can also be used advantageously when the water is fed from the body of water. In this way, in addition to the exchange of water in the aquaculture system, which takes place continuously anyway, the oxygen content and the nitrogen content in the water can be influenced. In this way, it can be ensured that there is always a sufficient oxygen content and a sufficiently low nitrogen content in the water within the aquaculture system, even if there is a high occupancy density with the aquatic organisms.

Expediently, the aquaculture system is configured in such a way that, in the case of closed operation, the water can be moved in a circulating manner in the aquaculture system. For this purpose, the aquaculture system is preferably provided with a pump provided for this purpose.

In one configuration of the invention, the aquaculture system has at least one tank, which is preferably arranged in the hull of the watercraft and in which the organisms to be farmed are to be kept. The tank is expediently arranged in the hull at least sectionally below the waterline of the watercraft. The interior space of the tank expediently has a cylindrical, preferably circular-cylindrical, shape. It goes without saying that it could also have the shape of a cuboid or a sphere.

In one embodiment of the invention, a feed line by means of which the tank is fed with water opens out into the tank in such a way that, when water is being fed, a circulating and/or rotating flow is formed in the tank. Expediently, for this purpose, the feed line is arranged in such a way that the water is fed parallel or at least almost parallel to an inner wall of the tank. Keeping the organisms in the tank in the presence of flow has the advantage that it is possible to set conditions in the tank that are similar to a natural environment.

Furthermore, it could be provided that an outlet line for discharging water from the tank is arranged in the tank in such a way that the release of water into the outlet line is also beneficial for the formation of the flow.

In a particularly preferred embodiment of the invention, the tank has a lower tank region and an upper tank region, which is arranged above the lower tank region. A tank interior space in the upper tank region expediently has, in plan view, a smaller cross-sectional area than in the lower tank region. The cross-sectional area, in the lower tank region, is preferably at least twice as large, particularly preferably at least three times as large, as that in the upper tank region. Expediently, an aeration portion of the upper tank region, which is connected in terms of flow to ambient air, is arranged above the waterline of the watercraft and a filling portion of the upper tank region, which is intended for filling with water, is arranged below the waterline. Since the watercraft, when travelling on the body of water, moves continuously and is in particular not in a constant horizontal position, an input of energy is realized via the interface between the water in the tank and the air. Said input of energy should be as small as possible in order not to adversely affect the organisms to be farmed. According to the invention, this is achieved in that the stated cross-sectional area in the upper tank portion is smaller than that in the lower tank portion.

Expediently, the tank is filled with the water to such a height that, in the upper tank region, an interface between the water in the tank and the air is formed. However, the interface and accordingly also the stated cross-sectional area in the upper tank region are preferably of such a size that the organisms to be bred, in particular fish, are, in a manner appropriate to their natural behavior, able to swim to the interface, and that, as a result thereof, light can enter the tank.

In one configuration of the invention, the upper tank portion has such a height that the tank, in particular the upper tank portion, can be filled with water to such a height that the lower tank portion remains completely filled even if the ship tilts to one side by up to 20°, which can be realized for example in the case of sailing. Expediently, the upper tank portion is arranged substantially centrally on the lower tank portion. Preferably, the upper tank portion has such a height that water, even in the case of maximum stagnation, cannot pass out from an upper opening of the upper tank portion.

In a further configuration of the invention, the aquaculture system has at least two or more of the tanks for holding the organisms to be farmed. Expediently, the tanks have mutually differently sized volumes as habitat for the organisms. It proves to be advantageous to provide tanks of different volumes in particular if the organisms are farmed in mutually separated shoals whose organisms are in each case of approximately the same size and/or the same age and the organisms of the different shoals are accommodated in different tanks, which are matched to the size and/or the age of the organisms and the accordingly differently sized habitats required. In one embodiment of the invention, the tanks are connected to one another by a line in such a way that the organisms to be farmed can be moved from one of the tanks into another of the tanks, wherein the line can preferably be closed off. Advantageously, the organisms can be relocated from one tank into the other tank if this becomes necessary owing to the growth of the organisms.

In one embodiment of the invention, different groups of in each case interconnected tanks are provided on the watercraft, wherein the tanks within in each case one group preferably have volumes of successively increasing size. The tanks of in each case one group are preferably connected to one another in such a way that the organisms for relocation can pass from one tank in each case into the next-larger tank. Expediently, the tanks are arranged on the watercraft at different heights, as a result of which the organisms, where necessary, can be relocated particularly easily from one tank to the other tank.

It has proven to be advantageous to arrange the tanks of a group one behind the other in the longitudinal direction of the ship or one behind the other in the direction perpendicular to the longitudinal direction of the ship. Advantageously, the water can then be moved particularly easily through the tanks. It goes without saying that two or more of the groups may be arranged one next to the other.

In one refinement of the invention, the stated feed device is configured for setting a volumetric flow rate at which the tank(s) is/are fed the water. Expediently, the setting device, which is preferably formed by a valve, is provided for setting volumetric flow rates of different magnitudes for the tanks. This is necessary for being able to match the flow speed to the differently sized tanks and to the respective living conditions for the organisms.

In a further configuration of the invention, the watercraft has at least one ballast water tank, by means of which, through filling or emptying, the draft of the watercraft can be changed, in particular to be able to match the position of the watercraft in the body of water to the respective load. The ballast water tank is expediently connected by a preferably closable line to the tank of the aquaculture system in such a way that the water can pass, in particular can be pumped, from the ballast water tank into the tank of the aquaculture system and vice versa. Advantageously, use may be made of the water from the ballast water tank, for example in an emergency, to supply fresh water to the organisms.

In a further refinement of the invention, the watercraft has a system for cultivating plants in a hydroponic culture. Expediently, the hydroponic culture system is connected to the aquaculture system in such a way that water exiting the aquaculture system and/or excreta or at least parts separated parts thereof, possibly separated by filtering or subjected to processing, occurring in the aquaculture system are/is fed to the hydroponic culture as nutrients for the plants.

The invention will be discussed in more detail below on the basis of exemplary embodiments and the appended drawing, the drawings referring to the exemplary embodiments. In the drawings, schematically:

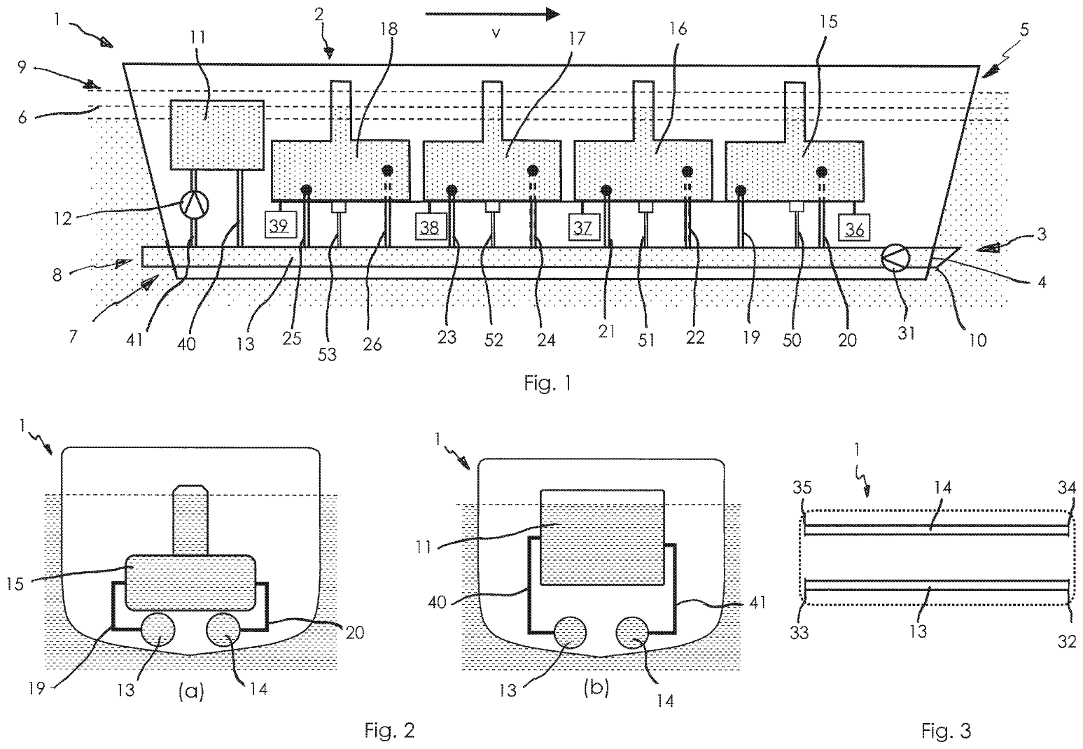

FIG. 1 shows a watercraft according to the invention,

FIG. 2 shows the watercraft from FIG. 1 in different sectional views,

FIGS. 3 to 8 show details of the watercraft from FIG. 1,

FIG. 9 shows a detail of a further watercraft, and

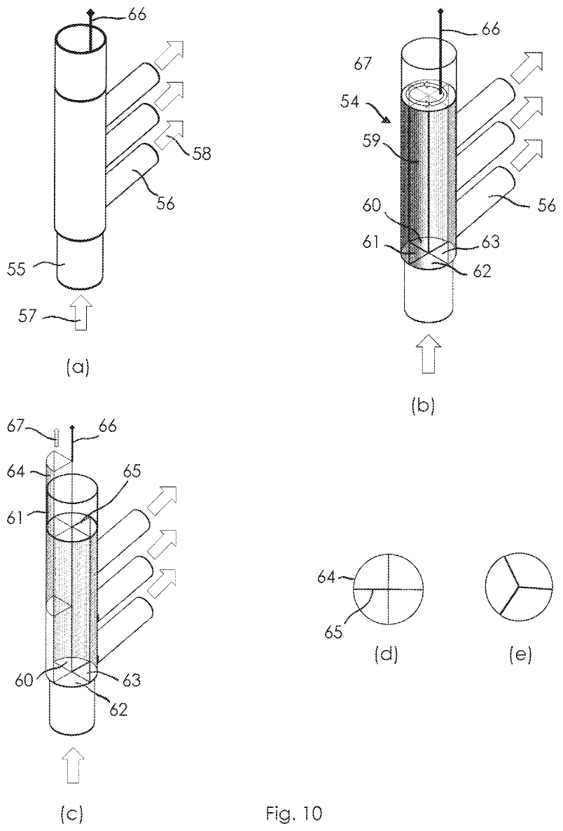

FIG. 10 shows a detail of a further watercraft.

FIG. 1 schematically illustrates, in a side view, a watercraft 1 in which there is arranged an aquaculture system 2 which can be used for breeding of aquatic organisms, in particular of fish, mollusks, crustaceans or algae. Said aquaculture system has four tanks 15, 16, 17, 18 in which the fish to be bred are kept. It goes without saying that the watercraft 1 may also have more than the mere four tanks 15, 16, 17, 18 shown here. As can also be seen in FIGS. 2 and 3, pipelines 13, 14, which extend from the bow 5 to the stern 9 of the watercraft 1, are formed below the tanks. In order for entry into the pipelines 13, 14 or therefrom for water from a body of water in which the watercraft 1 is arranged to be possible, openings 4, 8 are formed in the hull of the watercraft 1, which openings can be closed off by means of closure devices 32, 33, 34, 35, the arrangement of which is shown schematically in FIG. 3 and which can be formed for example by flaps or valves. At the openings 4 at the bow 5 and possibly also at those at the stern, it is possible to arrange material-separating apparatuses such as filters 10, in particular grid filters, by means of which the entry of impurities into the aquaculture system can be avoided. The filters 10 may be arranged in an adjustable manner, such that they can be moved into a filtering position, in which they are arranged before or at the opening and filter the water entering the openings 4, 8, or into an outlet position, in which they open up the openings 4, 8 if water is to be drained from the aquaculture system through the openings 4, 8.

The tanks 15, 16, 17, 18 are connected to the pipeline 13 via lines 19, 21, 23, 25 and to the pipeline 14 via lines 20, 22, 24, 26. Furthermore, on the tanks 15, 16, 17, 18, there are arranged drainage devices 50, 51, 52, 53, which in each case comprise a comminution pump and via which the waste materials are discharged from the tanks 15, 16, 17, 18 into the body of water.

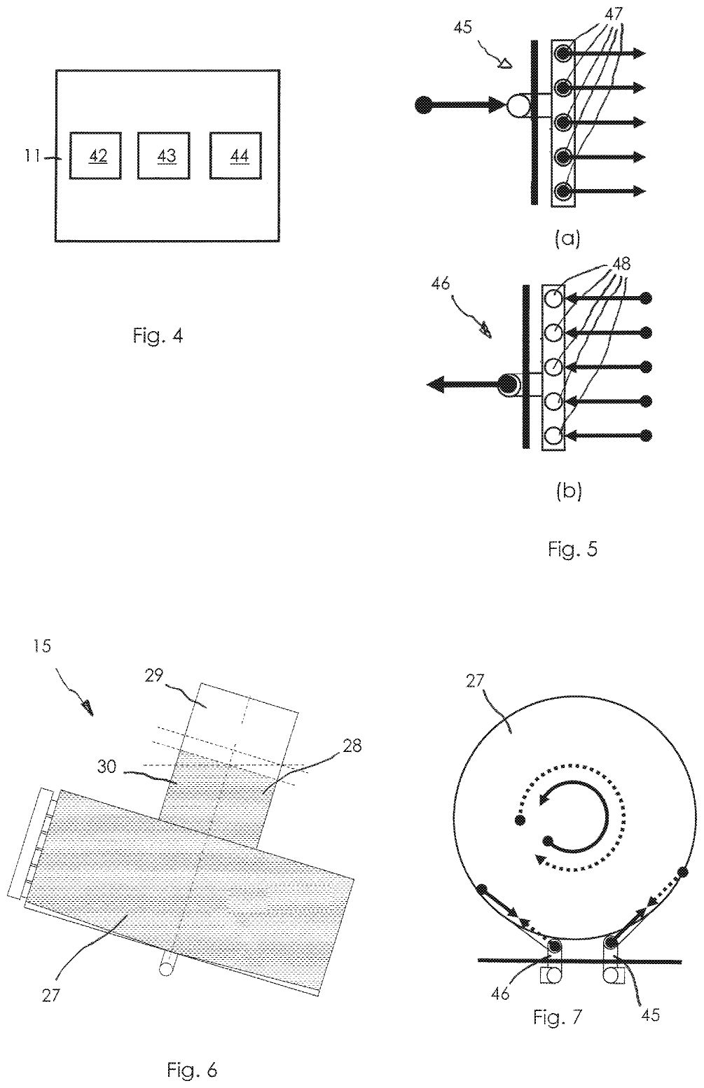

The aquaculture system furthermore comprises a device 11 for water treatment, which is connected to the pipelines 13, 14 via lines 40, 41. As FIG. 4 schematically shows, the water treatment device 11 comprises a device 42 for cleaning the water of solid materials, for example by filtration, flotation or sedimentation, a device 43 for introducing and/or removing gas, and a denitrification and/or nitrification device 44. A pump 12, by means of which the water can be pumped through the water treatment device 11, is provided at the line 40.

Optionally, each of the tanks 15, 16, 17, 18 may additionally be provided with in each case one water treatment unit 36-39, by means of which for example the oxygen content in the water can be increased and/or the nitrogen content in the water can be reduced. Such a water treatment device 36-39 could for example be an oxygen concentrator, as is conventionally used for aquaculture systems.

As can be seen in FIG. 5, at the feed and discharge lines 19-26 for the tanks 15, 16, 17, 18, there are arranged devices 45, 46 for setting a volumetric flow rate at which the water enters the tanks 15, 16, 17, 18 or is moved therefrom. The magnitude of the volumetric flow rate can be changed in that openings 47 through which the water enters the respective tank 15, 16, 17, 18 or openings 48 through which the water is conducted out of the tanks 15, 16, 17, 18 can be individually opened and/or closed. It goes without saying that it is also possible for the respective setting devices 45, 46 to be provided such that they can be opened and/or closed fully, preferably independently of one another.

FIG. 10 shows a separating device 54 which comprises pipes 55, 56 of a pipeline, and comprises a filter device 59 which has four filter parts 60, 61, 62, 63 which can be assembled to form the filter device.

The filter parts 60, 61, 62, 63 have filter grids 64 which, when arranged together in the filter device 59, form a hollow circular cylinder. For mechanical stabilization of the filter grids, the filter parts 60, 61, 62, 63 have in each case one connecting bar 65. Each of the filter parts 60, 61, 62, 63 forms, as is shown in particular in FIGS. 10d and 10e, in each case one quarter segment or one third segment of the filter device 59. It goes without saying that, alternatively, other segment sizes and/or another size division of the segment sizes could be provided.

The filter device 59 is arranged rotatably in a feed pipe 55 of the pipeline, as is shown by means of the arrows 67. The rotation can be carried out by means of an actuating device 66, which is introduced into the feed pipe 55. By means of the actuating device 66, it is furthermore possible for in each case one of the filter parts 60, 61, 62, 63 to be removed from the filter device 59 in order to clean it.

During the operation of the separating device 54, the filter device 59 is arranged in the feed pipe 55 in such a way that a filter grid 64 of one of the filter parts 60, 61, 62, 63 completely covers openings are formed in the discharge pipes 56 of the pipeline. Water which enters the filter device 59 (flow direction shown by arrow 57) is filtered by means of the filter grid 64 upon entry into the discharge pipes 56 and collected material is held on the filter grid 64. As soon as the respective filter part 60, 61, 62, 63 is to be cleaned, the filter device 59 is rotated to such an extent that a filter grid of another filter part completely covers the openings leading to the discharge pipes 56. The previously used filter part 60, 61, 62, 63 can then, as is shown in FIG. 10c, be removed from the filter device 59 in the direction of the arrow 68 by means of the actuating device 66. After being cleaned, the filter part 60, 61, 62, 63 can be re-inserted into the filter device 59. During operation, the above-described procedure can be repeated successively.

Advantageously, the separating device 54 may continue to be operated even during the cleaning of the individual filter parts 60, 61, 62, 63.

It goes without saying that the discharge pipes 56 can, in a manner analogous to that described above for FIG. 5, be closed off and opened individually, in order for it to be possible to control how much water is admitted in the respective tank 15, 16, 17, 18.

The separating device 54 described and the filter device 59 can also advantageously be used for filtering liquids in other apparatuses independently of the watercraft described here.

FIGS. 6 and 7 illustrate the shapes of the tanks 15, 16, 17, 18 by way of example on the basis of the tank 15. The interior space of the tank 15 comprises a lower tank region 27 and an upper tank region 28, which has a significantly smaller inner diameter in comparison with the lower tank region 27. The lower tank region 27, which is shown in a horizontal section in FIG. 9, has a hollow-cylindrical shape. During the operation of the aquaculture system 2, the lower tank region 27 is completely filled with water and the upper tank region 28 is partially filled with water in a filling portion 30. The upper tank region 28 is expediently filled with water to such a height that the tank 15, even in the case in which it is arranged so as to be tilted with respect to the horizontal, is still completely filled at least at the lower end of the upper tank region 28. Furthermore, its maximum filling height is such that the water does not run out from the upper tank region 28 at the top even if the tank 15 is tilted by an angle of 20° away from the horizontal. The upper end of the upper tank region 28 has an opening through which air and light can enter the tank region 28 via an aeration portion 29.

As can be seen in particular in FIG. 7, the setting devices 45, 46 are connected to the tank 15 in such a way that, during the inflow and outflow through the setting devices 45, 46, the water arranged in the tank 15 is caused to flow in a manner moved in rotation about the longitudinal axis of the interior space of the tank 15.

For operating the watercraft 1 and the aquaculture system 2 arranged therein, the watercraft 1 is firstly arranged in a body of water in which aquaculture is intended to be carried out, and the pipelines 13, 14, the tanks 15, 16, 17, 18 and the water treatment device 11 are flooded with water such that the tanks 15, 16, 17, 18 and the water treatment device 11 are filled with water up to the waterline 6 of the watercraft. The organisms to be bred can then be put into the tanks 15, 16, 17, 18.

The tanks 15, 16, 17, 18 can be fed with water from the body of water when the watercraft 1 is moved in the body of water. The movement of the watercraft may be realized by motor-powered drive. It is preferable, however, for the watercraft to be provided with sails, so that it can be driven by wind. Said watercraft may therefore be in the form of a sailboat or sailing ship.

In order for it to be possible for the tanks 15, 16, 17, 18 to be loaded with water when the watercraft is moved, the closure device 32 of the pipeline 13 is opened, the closure device 33 of the pipeline 13 is closed, and the closure device 34 of the pipeline 14 is closed and the closure device 35 of the pipeline 14 is opened. If the watercraft 1 is then moved in the direction of the arrow v, a stagnation pressure 1 is built up at the bow 5 of the watercraft 1, owing to which stagnation pressure water is pushed into the pipeline 13. Under the stagnation pressure, water is moved into the tanks 15, 16, 17, 18 from the pipeline 13 through the line 19, 21, 23, 25 and, from the tanks 15, 16, 17, 18, water is again moved into the pipeline 14 through the lines 20, 22, 24, 26. From the pipeline 15, the water from the tanks 15, 16, 17, 18 is drained into the body of water again through the opening 8. As a result of the feeding of water into the tanks 15, 16, 17, 18 through the setting device 45 and the removal through the setting device 46, in the tanks 15, 16, 17, 18, firstly the water is set in rotation, and secondly it is ensured that the tanks 15, 16, 17, 18 are continuously supplied with fresh water and water is continuously conveyed away from the tanks 15, 16, 17, 18 again. Since the stagnation pressure, by way of which the water is pushed into the pipeline 13, depends on the speed at which the watercraft 1 is moved on the body of water and it is necessary to set the speed at which the water rotates in the tanks 15, 16, 17, 18, the setting of the number of openings 47, 48 of the setting devices 45, 46 is expediently realized in a manner dependent on the travel speed of the watercraft 1 and, for this purpose, said number is preferably regulated by means of a regulation means provided for this purpose.

Since, depending on the occupancy of the tanks 15, 16, 17, 18 with fish, it may be necessary, the continuous feeding of fresh water into the tanks 15, 16, 17, 18 becomes out, to enrich the water with oxygen, and/or to reduce the nitrogen content in the water, in order to ensure that the health of the fish is maintained, the oxygen and/or nitrogen content can be influenced by means of the oxygen and/or nitrogen regulation devices 36-39.

The flow direction of the water within the aquaculture system 2 can be changed in that, conversely with respect to the above-stated position of the closure devices 32-35, the closure devices 34 and 33 are opened and the closure devices 32 and 35 are closed. In this case, the water, under the stated stagnation pressure, then flows into the pipeline 14 and, after flowing through the tanks 15, 16, 17, 18, flows away again via the pipeline 13. Advantageously, through changing of the flow direction, the fish can be made to move in the tanks in the opposite direction, counter to the flow prevailing there. In this way, uneven muscular development of the fish can be avoided. Furthermore, the closure devices 32-35 can be positioned in such a way that the stated filters can be backflushed.

If the watercraft 1 is not moved, for example because there is no wind which could drive the watercraft 1, water can be pumped into the pipeline 13 from the body of water by means of the pump 31. For sufficient pump power, the tanks 15, 16, 17, 18 are supplied with fresh water in the same manner as when the watercraft 1 is driven.

If the aquaculture system 2 has to be separated from the body of water, for example because it does not have a sufficiently good water quality, all the closure devices 32, 33, 34, 35 are closed. In order to provide the fish in the tanks 15, 16, 17, 18 with water of sufficiently good quality, the water arranged in the aquaculture system 2 is pumped by means of the pump 12 through the water treatment system 11 and cleaned and supplied with gas within the water treatment system 11. In order to ensure that a sufficient exchange of water takes place in the tanks 15, 16, 17, 18, further pumps can be provided in the aquaculture system 2, for example at the lines 19-26 or at the pipelines 13, 14.

As a result of the two-part construction of the tanks 15, 16, 17, 18, which is shown in particular in FIG. 6, it is achieved that an only relatively small interface between water and air, via which interface energy can be input into the water in the tanks, is formed, so as to avoid the fish being disturbed owing to an excessively large energy input due to the movement of the watercraft 1. However, as a result of the opening, it is achieved that air can pass to the water, so that the fish, as is appropriate to their natural behavior, are able to swim to a water surface adjoining air. The tank construction proves to be particularly advantageous if natural or artificial light can pass through the opening at the upper edge of the upper tank portion 28, since this too can promote the impression of a natural environment in the case of the fish.

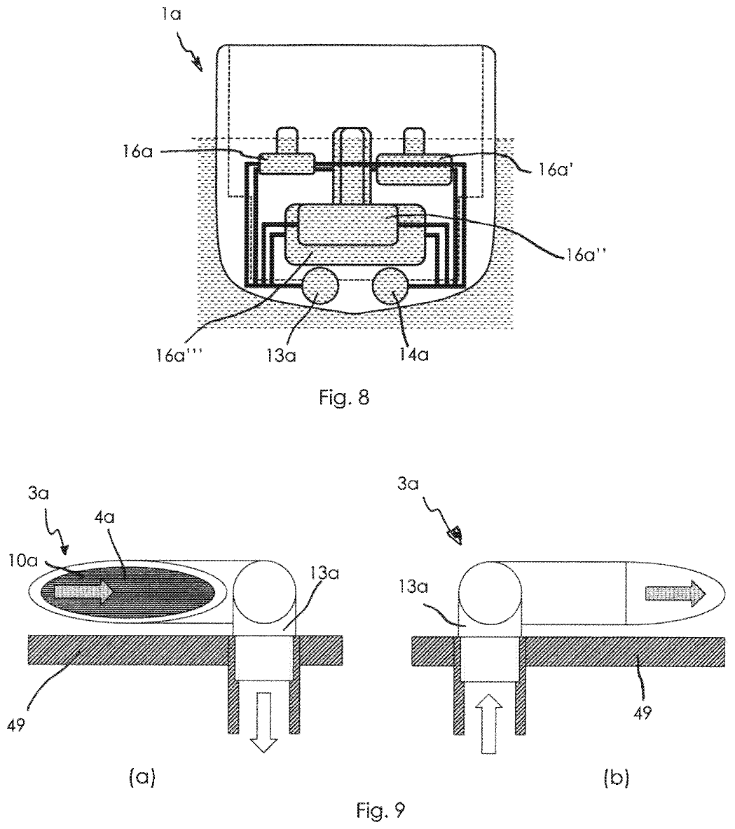

As can be seen in FIG. 8, it is also possible, as an alternative to the above-described exemplary embodiment, for tanks 16a-16a′″ of different volumes to be provided. This proves to be advantageous if shoals of fish which are each of approximately the same size and/or the same age and the fish of the different shoals are accommodated according to their age or their size in tanks 16a-16a′″ which are matched to the size and/or the age of the fish and the accordingly differently sized habitats required. The young and relatively small fish are initially kept in small tanks 16a, and subsequently relocated to the in each case larger tanks 16a′, 16a″, 16a′″.

In deviation from the illustration in FIG. 1, a watercraft could have, instead of each of the tanks 15, 16, 17, 18, in each case one group of differently sized tanks 16a-16a′″, which is as shown in FIG. 8. Based on the example from FIG. 1, the watercraft would then have in each case four groups of in each case four differently sized tanks 16a-16a′″.

It proves to be advantageous to provide tanks of different volumes in particular if the organisms are farmed in mutually separated shoals whose organisms are in each case of approximately the same size and/or the same age and the organisms of the different shoals are accommodated in different tanks, which are matched to the size and/or the age of the organisms and the accordingly differently sized habitats required.

FIG. 9 illustrates an alternative device 3a for feeding water from the body of water and/or discharging water thereto. The feed device 3a, which particularly advantageously could be provided on a longitudinal side 49 of the watercraft, that is to say port or starboard side of the hull or, in the case of twin-hull or multi-hull ships, on one or more longitudinal sides of the hulls, has a feed opening 4a in which a filter 10a is arranged and which is adjoined by a pipeline 13a by means of which fresh water can be moved into the aquaculture system. The feed device 4a proves to be advantageous in particular if it is arranged rotatably on the hull. This is because, as is shown in FIG. 9a, the feed opening 4a can then be oriented in the travel direction of the watercraft 1, so that, when the watercraft 1 is traveling, water flows from the body of water directly into the feed opening 4a. Moreover, the feed opening 4a can be oriented in the opposite direction through pivoting of the feed device 3a and then used for discharging used water. If two of the feed devices 3a are arranged on the longitudinal side(s) of the hull, one may serve as feed device and the other one may serve for discharge. Through respective reversal of the orientations of the feed devices 3a, it is then possible for the flow direction in the aquaculture system to be reversed, on the one hand, and for the respective filter 10a to be backflushed, on the other hand.

The pipeline 13a may be connected to a pipeline system, as is shown in FIG. 1, 2 or 8. The pipeline 13a may open out into another pipeline, which is arranged parallel, perpendicularly or transversely to the longitudinal axis of the watercraft. It goes without saying that the watercraft may have two or more of the feed and/or outlet devices 3a, which are possibly connected to one another by a line.

In a further exemplary embodiment, at the position at which a pump is identified with the reference sign 31 in FIG. 1, there is provided a turbomachine 31 which can be used both as pump and as turbine for generation of energy. If the watercraft 1 is in the form of a sailboat and the ship were driven by wind faster than is necessary to move the watercraft 1 at a speed which permits a supply of water to the aquaculture system 2 owing to the movement of the watercraft 1, electrical energy can be generated using the turbine owing to the flow of the water through the pipeline 13. The electrical energy may, for example, be used for operating the aquaculture system or be stored in a battery, in order that it is available for later use in the watercraft 1. The amount of electrical energy absorbed using the turbine 31 can, in a manner dependent on the travel speed of the watercraft 1 relative to the water of the body of water, be regulated in such a way that the watercraft 1 at all times travels at a travel speed which is sufficiently large for supplying water to the aquaculture system.

1-20. (canceled)

21. A watercraft for production of aquatic organisms, comprising: an aquaculture system arranged in the watercraft; and a feed device for feeding water into the aquaculture system, the feed device being configured to take water from a body of water in which the watercraft is floating.

22. The watercraft according to claim 21, wherein the aquaculture system is configured for farming and/or breeding fish.

23. The watercraft according to claim 21, wherein the feed device has a feed opening for receiving the water from the body of water, the feed opening being open in a longitudinal direction of the watercraft and/or being arranged below a waterline of the watercraft.

24. The watercraft according to claim 23, further comprising a hull, wherein the feed opening is arranged in the hull of the watercraft.

25. The watercraft according to claim 24, wherein the feed opening is arranged in a bow of the hull.

26. The watercraft according to claim 24, further comprising an outlet device for discharging water from the aquaculture system into the body of water, wherein the outlet device has an outlet opening open in the longitudinal direction of the watercraft and/or arranged below the waterline of the watercraft.

27. The watercraft according to claim 26, wherein the outlet opening is arranged in the hull of the watercraft.

28. The watercraft according to claim 27, wherein the outlet opening is arranged in a stern of the hull.

29. The watercraft according to claim 23, further comprising a material-separating device arranged at the feed opening.

30. The watercraft according to claim 29, wherein the material-separating device is a filter and/or a rake, and the feed device is operatively configured to clean the filter by backflushing.

31. The watercraft according to claim 21, further comprising a filter device having a plurality of filter parts, wherein, for cleaning, each of the filter parts is removable from the filter device in each case individually and separately from the other filter parts.

32. The watercraft according to claim 31, wherein the filter device has a cylindrical shape so as to be arrangeable in a fitting manner in a pipeline.

33. The watercraft according to claim 31, wherein the filter device is configured so that the filter parts are rotatable between a filtering position in which the filter parts filter the water passing through, and a removal position in which the filter parts are removable from the filter device for cleaning.

34. The watercraft according to claim 26, wherein the feed device and/or the outlet device is configured to selectively closed off with respect to the body of water in order to separate the aquaculture system from the body of water.

35. The watercraft according to claim 21, wherein the aquaculture system includes a device for treating the water that is configured for removing solid materials, for introducing and/or removing gas, and for nitrification and/or for denitrification.

36. The watercraft according to claim 21, wherein the aquaculture system includes at least one pump by which the water is conveyed in a circulating manner within the aquaculture system.

37. The watercraft according to claim 21, wherein the aquaculture system includes a line formed by a pipeline and/or by an open watercourse.

38. The watercraft according to claim 37, wherein the open watercourse is a channel.

39. The watercraft according to claim 21, further comprising a hull, wherein the aquaculture system includes at least one tank in which organisms to be bred are to be kept, and the tank is arranged in the hull so as to be at least sectionally below the waterline of the watercraft.

40. The watercraft according to claim 39, wherein the tank has a lower tank region and an upper tank region arranged above the lower tank region, and an interior space of the tank has a smaller cross-sectional area in the upper tank region than in the lower tank region.

41. The watercraft according to claim 40, wherein the upper tank region has an aeration portion, which is connected in terms of flow to ambient air, arranged above the waterline and a filling portion, which is intended for filling with water, arranged below the waterline.

42. The watercraft according to claim 39, wherein the aquaculture system comprises at least two tanks, which have mutually differently sized volumes for receiving the organisms to be bred, wherein the tanks are connected to one another by a line so that the organisms to be bred can be moved from one of the tanks into another of the tanks.

43. The watercraft according to claim 39, wherein the feed device is configured for setting a volumetric flow rate of water at which the at least one tank is loaded.

44. The watercraft according to claim 43, wherein the aquaculture system includes more than one tank, and the feed device is configured to set volumetric flow rates of different magnitudes for each of the tanks.

45. The watercraft according to claim 21, further comprising a turbomachine configured to generate electrical energy from a flow of water relative to the watercraft as the watercraft moves in the body of water.

46. The watercraft according to claim 45, further comprising a regulating device configured to regulate a travel speed of the watercraft relative to the water of the body of water, to regulate energy absorption by the turbomachine and/or to regulate a throughflow rate of the water through the aquaculture system, wherein a manipulated variable of the regulation is the variable of the energy absorption by the turbomachine.

47. The watercraft according to claim 21, wherein the watercraft is a sailing ship.

48. A method for production of aquatic organisms, comprising the steps of: arranging an aquaculture system in and/or on a watercraft; keeping the aquatic organisms in the aquaculture system; and operating the aquaculture system by moving water into the aquaculture system from a body of water in which the watercraft is floating.

49. The method according to claim 48, including continuously moving water from the body of water into the aquaculture system, and continuously releasing water, together with impurities produced by the organisms, from the aquaculture system into the body of water.

50. The method according to claim 48, wherein the watercraft is a sailing ship, further comprising generating electrical energy by a turbomachine when the watercraft is moving in the body of water by using a flow of the water relative to the watercraft, and regulating a travel speed of the watercraft relative to the water of the body of water, an energy absorption by the turbomachine and/or a throughflow rate of the water through the aquaculture system.
